(19) United States
(12) Patent Application Publication
(10) Pub. No.: US 2012/0193380 A1
(43) Pub. Date: Aug. 2, 2012

(54) Vehicle Rack Mount Apparatus

(76) Inventor: Robert McMurtrie, Phoenixville, PA (US)

(21) Appl. No.: 13/361,913

(22) Filed: Jan. 30, 2012

Related U.S. Application Data
(60) Provisional application No. 61/438,018, filed on Jan. 31, 2011.

(51) Int. Cl. B60R 9/048

(52) U.S. Cl. 224/324

(57) ABSTRACT

The present invention generally relates to a vehicle rack mount. Specifically, an apparatus that mounts to the roll bar of a convertible vehicle without need to be attached to a secondary affixing point, the apparatus comprised of a base plate, two rack arms and a rack bar. The vehicle rack mount apparatus, in accordance with an exemplary embodiment of the present invention, is designed to be fixably mounted to the roll bar of a Jeep® Wrangler®. Although an exemplary embodiment of the present invention is intended for use with the aforementioned vehicle, one of ordinary skill in the art would appreciate that embodiments of the present invention may work with any vehicle with a similar roll bar setup, and embodiments of the present invention are contemplated for use with vehicles with similar roll bar setups.

### CROSS REFERENCE TO RELATED APPLICATIONS

This application claims the benefit of U.S. Provisional Patent Application No. 61/438,018 filed Jan. 31, 2011, the entire disclosure of which is incorporated herein by reference.

### FIELD OF THE INVENTION

The present invention generally relates to a vehicle rack mount. Specifically, an apparatus that mounts to the roll bar of a convertible vehicle without need to be attached to a secondary affixing point, the apparatus comprised of a base plate, two rack arms capable of receiving a rack bar. The bar is not a part of the invention.

### BACKGROUND

Convertible vehicles and other forms of vehicles with roll bars have been a fixture of our automotive landscape for decades. One feature lost on most convertible vehicles is the ability to store or otherwise carry loads on the roof of the vehicle. To offset this limitation, numerous companies have developed apparatuses designed to allow mounting of loads or items, such as skis, kayaks, bicycles and cases, to the roll bars.

One drawback with these mounting apparatuses is that they all require multiple affixing points in order to function fully. Most commonly, these apparatuses are required to be affixed to the roll bar as well as a windshield frame or secondary roll bar or mounting point as well. A common example is the mounting of one of these apparatuses on a Jeep® Wrangler®, where mounting on the side roll bars is required.

The requirement of multiple mount points increases the complexity of securing and mounting loads thereupon. Further, since most of the mounting apparatuses block or otherwise prevent the convertible top from being put up, the removal or alteration of these mounting apparatuses is required each time the convertible top is used.

Therefore, there is a need in the art for an apparatus that utilizes a single affixing point while still allowing for the retention and securing of a load or other item on a roll bar of a convertible vehicle. These and other features and advantages of the present invention will be explained and will become obvious to one skilled in the art through the summary of the invention that follows.

### SUMMARY OF THE INVENTION

Accordingly, it is an object of the present invention to provide an apparatus that mounts to the roll bar of a convertible vehicle without need to be attached to a secondary affixing point, the apparatus comprised of a base plate, two rack arms capable of receiving a rack bar.

According to an embodiment of the present invention, the base plate of the apparatus is comprised of a substantially rectangular plate.

According to an embodiment of the present invention, the base plate's width and length would be roughly equivalent to that of the roll bar the base plate attaches to.

According to an embodiment of the present invention, the height of the base plate may vary.

According to an embodiment of the present invention, the base plate would be further comprised of two or more holes capable of receiving one or more affixing devices through the entire height of the base plate. Affixing devices may include, but are not limited to, wing nuts, screws or bolts.

According to an embodiment of the present invention, the affixing devices may be utilized with dampening devices to reduce the chance of damage to the roll bar of the vehicle. Dampening devices may include, but are not limited to, rubber washers, metal washers and rubber plugs.

According to an embodiment of the present invention, the base plate may be affixed to a roll bar of a vehicle with one or more affixing devices.

According to an embodiment of the present invention, water tight holes may be created in a removable top of a vehicle to allow for the base plate to be affixed to the vehicle while the removable top is up.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a front view of a vehicle rack mount apparatus, in accordance with an embodiment of the present invention;

FIG. 2 is a side view of a vehicle rack mount apparatus, in accordance with an embodiment of the present invention;

FIG. 3 is a top view of a vehicle rack mount apparatus, in accordance with an embodiment of the present invention;

FIG. 4 is a perspective view of a vehicle rack mount apparatus, in accordance with an embodiment of the present invention, shown mounted to a vehicle;

FIG. 5 is a side view of a vehicle rack mount apparatus, in accordance with an embodiment of the present invention, shown mounted to a vehicle; and

FIG. 6 is a side view of a vehicle rack mount apparatus, in accordance with an embodiment of the present invention.

### DETAILED SPECIFICATION

The present invention generally relates to a vehicle rack mount. Specifically, an apparatus that mounts to the roll bar of a convertible vehicle without need to be attached to a secondary affixing point, the apparatus comprised of a base plate, two rack arms capable of receiving a rack bar. The vehicle rack mount apparatus, in accordance with an exemplary embodiment of the present invention, is designed to be fixably mounted to the roll bar of a Jeep® Wrangler®. Although an exemplary embodiment of the present invention is intended for use with the aforementioned vehicle, one of ordinary skill in the art would appreciate that embodiments of the present invention may work with any vehicle with a similar roll bar setup, and embodiments of the present invention are contemplated for use with vehicles with similar roll bar setups. It really is unique to Jeep because of the existing two holes in the cross bar. These two holes are used to secure the “hard top”.

According to an embodiment of the present invention, the base plate of the apparatus is comprised of a substantially rectangular plate. In an exemplary embodiment of the present invention, the base plate's width and length would be roughly equivalent to that of the roll bar the base plate attaches to. The height of the base plate may vary, with an exemplary embodiment having a height of one inch. One of ordinary skill in the art would appreciate that the base plate may be constructed of any height, and embodiments of the present invention are contemplated for use with base plates of any height.

According to an embodiment of the present invention, the base plate would be further comprised of two or more holes capable of receiving one or more affixing devices through the entire height of the base plate. Affixing devices may include, but are not limited to, wing nuts, screws or bolts. One of ordinary skill in the art would appreciate there are numerous affixing devices that could be used with embodiments of the present invention, and embodiments of the present invention are contemplated for use with any type of affixing device. The affixing devices may be utilized with dampening devices to reduce the chance of damage to the roll bar of the vehicle. Dampening devices may include, but are not limited to, rubber washers, metal washers and rubber plugs. One of ordinary skill in the art would appreciate that any number of dampening devices may be used with embodiments of the present invention, and embodiments of the present invention are contemplated for use with any type of dampening device.

According to an embodiment of the present invention, the base plate may be affixed to a roll bar of a vehicle with one or more affixing devices. In the case of the Jeep® Wrangler®, two bolts may be used to affix the base plate to the roll bar of the vehicle when the removable top is down. In an alternate embodiment, water tight holes may be created in the removable top to allow for the base plate to be affixed to the vehicle while the removable top is up.

According to an embodiment of the present invention, the two rack arms, one located at each end of the base plate, extend upward perpendicular to the base plate. The two rack arms are affixed to the base plate. In an exemplary embodiment, in accordance with the present invention, the two rack arms are permanently affixed to the base plate by way of welded seams. One of ordinary skill in the art would appreciate that each rack arm may be permanently or removably affixed to the base plate in any number of manners, and embodiments of the present invention are contemplated for use with any type of method for permanently or removably affixing the rack arms to the base plate.

According to an embodiment of the present invention, each rack arm is substantially rectangular, being as wide as the width of the base plate and extend upward from the direction of the ground. At the top end of each rack arm is a receiving component, capable of receiving one end of a rack bar. The receiving component may be any component capable of receiving one end of a rack bar. For instance, according to an exemplary embodiment of the present invention, the receiving component may be shaped in a curved fashion with a circular hole running through the rack arm. Ideally, each rack arm would have a complimentary receiving component, capable of receiving an appropriate rack bar.

According to an embodiment of the present invention, the rack bar may be comprised of a bar that runs the length between the receiving component of the two rack arms. Each receiving component receives one end of the rack bar. Once an end of the rack bar is received in a receiving component, it may be removably affixed in or to the receiving component. An end of the rack bar may be removably affixed in or to a receiving component in a variety of manners, including, but not limited to, by way of screws tightened by an Allen wrench. One of ordinary skill in the art would appreciate that an end of the rack bar may be removably affixed in or to a receiving component in numerous manners, and embodiments of the present invention are contemplated for use with any manner of removably affixing an end of the rack bar in or to a receiving component.

According to an embodiment of the present invention, the entire vehicle rack mount apparatus herein described may be constructed of one or more durable materials, appropriate for mounting to a vehicle. For instance, in an exemplary embodiment in accordance with an embodiment of the present invention, the base plate and rack arms may be comprised of steel tubing with welded seams. One of ordinary skill in the art would appreciate that the vehicle rack mount apparatus, and the various components thereof, could be constructed from any number of durable materials, and embodiments of the present invention are contemplated for use with any durable material.

### Exemplary Embodiment

Listed below are specifications for a vehicle rack mount apparatus, in accordance with an embodiment of the present invention:
Vehicle rack mount apparatus is made of 1″×2″ rectangular steel tubing with welded seams
Dimensions: 48″ wide×2″ deep×5″ high
Inner diameter of each receiving component is 1¼″ and accommodates a 1″ rack bar
Rack bar is held in place with set screws at top of each collar tightened with an Allen wrench
Base plate is secured to a Jeep Wrangler with 5/16″×4.5″ bolts, 5/16×1.5″ rubber washers, 5/16×1.5″ metal washers, 5/16×1.5″ rubber plugs and wing nuts through two holes in base plate 7.5″ from the center of the base plate.

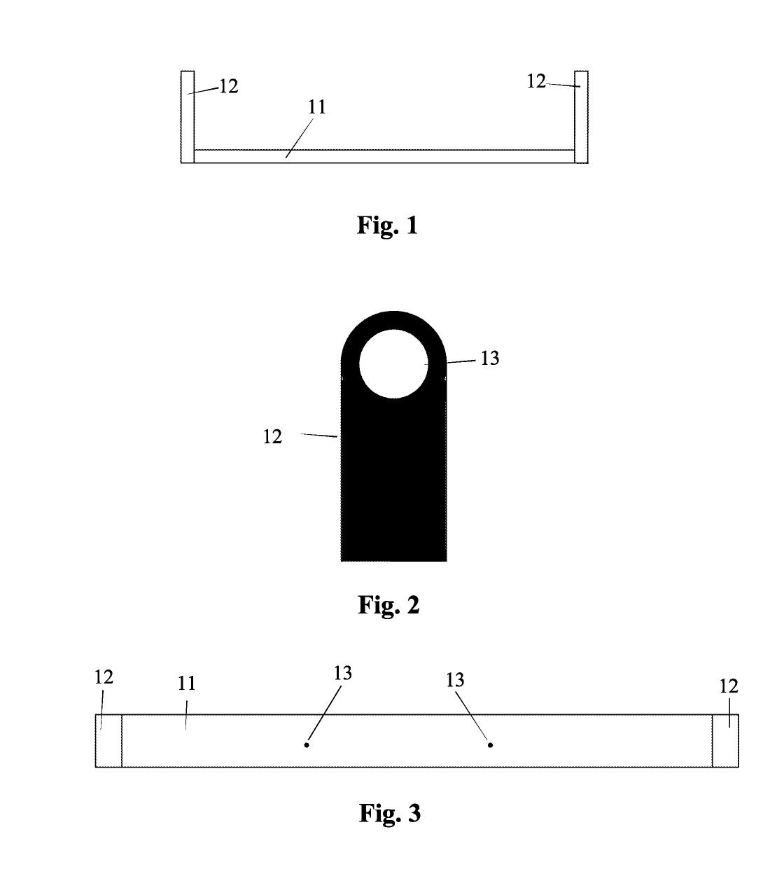

Turning now to FIG. 1, a front view of a vehicle rack mount apparatus, in accordance with an embodiment of the present invention, is shown. In this figure, the base plate 11 is shown horizontally laid with the two rack arms 12 extending vertically therefrom.

Turning now to FIG. 2, a side view of a vehicle rack mount apparatus, in accordance with an embodiment of the present invention, is shown. In this figure, a rack arm 12 is shown with a receiving component 13 passing through the rack arm 12. The receiving component 13 in this embodiment is a circular hole capable of receiving a rack bar (not shown).

Turning now to FIG. 3, a top view of a vehicle rack mount apparatus, in accordance with an embodiment of the present invention, is shown. In this figure, a base plate 11 is shown from a top view angle with two rack arms 12 extending therefrom. Further, from this top view of the base plate 11, two affixing devices 13 are shown. The two affixing devices are removably attached to the roll bar of a vehicle (not shown).

In a preferred embodiment, the two affixing devices 13 described above are configured to affix to existing point on the roll bar of the vehicle the apparatus is to be attached to. For instance, in a Jeep® Wrangler® or similar vehicle, the roll bars have multiple mounting points capable of receiving the affixing devices there through. The intended purpose for these mounting points is to secure a hard top or other convertible top to the vehicle. It is an object of the present invention to utilize these mounting points with the affixing devices of the present invention to affect the mounting of the apparatus without requiring any modification to the standard roll bar. This is advantageous in that no expensive or unsightly modifications are required to provide sturdy and reliable mounting points to a vehicle.

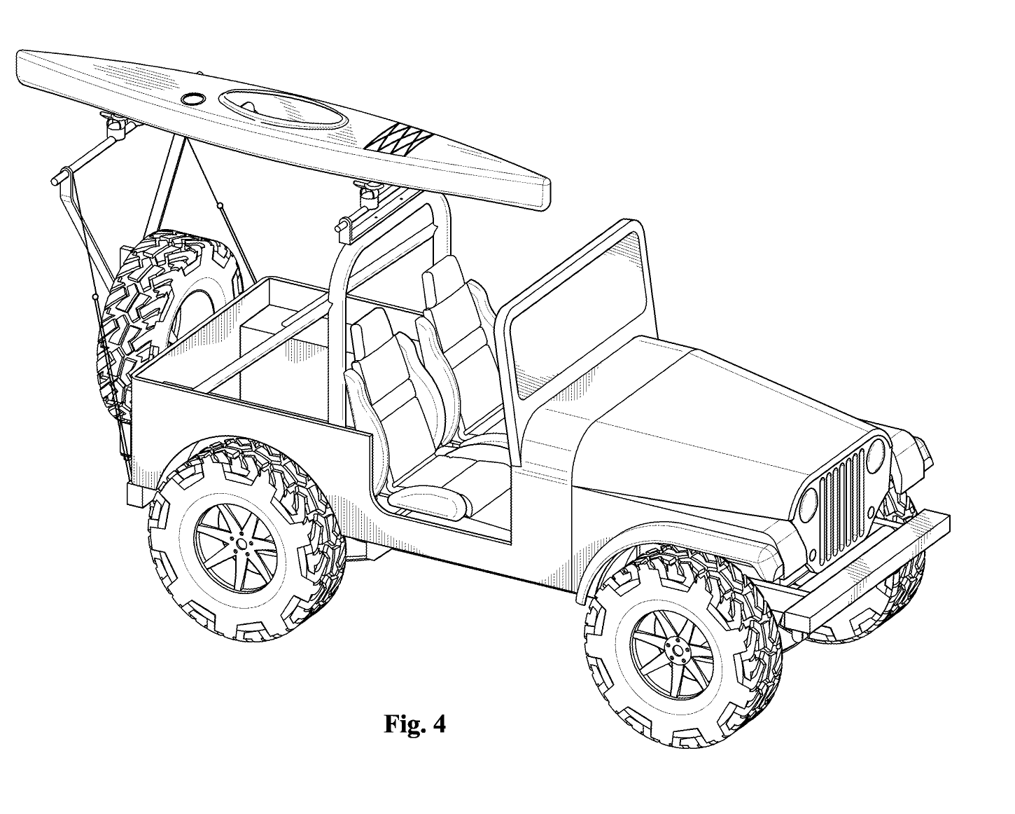

Turning now to FIG. 4, a perspective view of a vehicle rack mount apparatus, in accordance with an embodiment of the present invention, shown mounted to a vehicle, is illustrated. In this figure, the vehicle rack mount apparatus is shown mounted to the front roll bar of a Jeep® Wrangler® style vehicle. Further shown in this figure is an optional rear mounting means that attaches to rear component of the vehicle, such as a tow hook or spare tire mount.

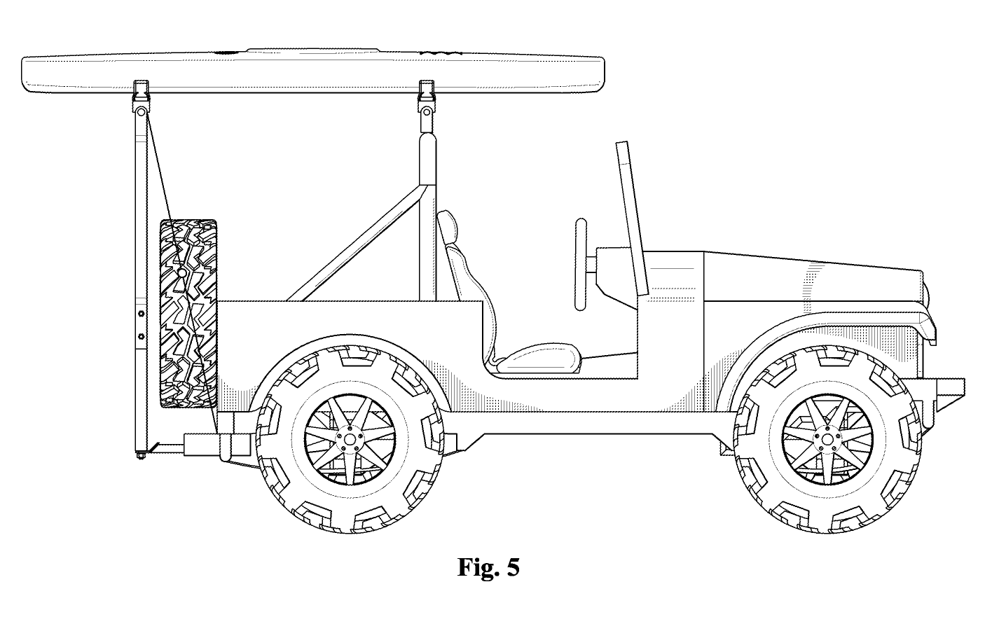

Turning now to FIG. 5, a side view of a vehicle rack mount apparatus, in accordance with an embodiment of the present invention, shown mounted to a vehicle, is illustrated. In this figure, the vehicle rack mount apparatus is shown mounted to the front roll bar of a Jeep® Wrangler® style vehicle. Further shown in this figure is an optional rear mounting means that attaches to rear component of the vehicle, such as a tow hook or spare tire mount.

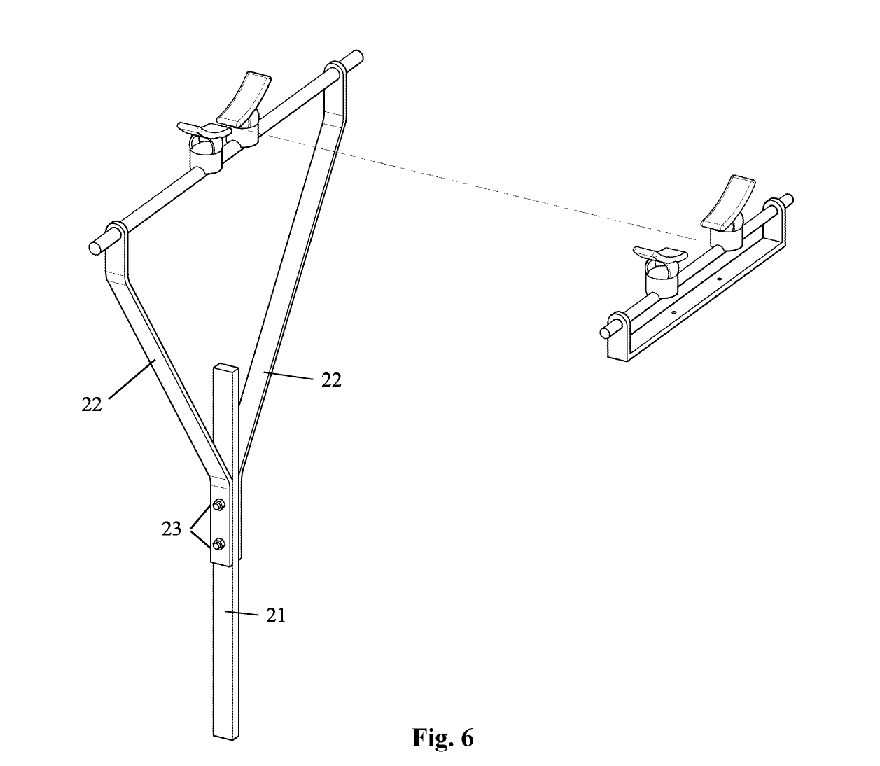

Turning now to FIG. 6, a perspective view of a vehicle rack mount apparatus and optional rear mounting means, in accordance with an embodiment of the present invention, is shown. Components of the optional rear mounting means include a base attachment means 21, two rear mounting means arms 22 and one or more affixing means 23. The optional mounting means is configured to attach to rear component of the vehicle, such as a tow hook or spare tire mount. The optional mounting means is designed to allow for the vehicle rack mount apparatus to retain large or unwieldy loads or items without jeopardizing the advantageous functionalities provided by embodiments of the present invention. Construction components may be similar as those used in the vehicle rack mount apparatus while construction dimensions will vary based upon vehicle type and mounting point. One of ordinary skill in the art would appreciate that there are numerous mounting point types and construction dimensions that could be utilized by embodiments of the present invention, and embodiments of the present invention are contemplated for use with any mounting point or construction dimension.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A vehicle rack mount apparatus, said apparatus comprising:
a base plate configured to receive one or more affixing means; and
two or more rack arms connected in a manner substantially perpendicular to said base plate, wherein each of said two or more rack arms is substantially parallel with the other rack arms,
wherein said base plate is configured to be affixed to a roll bar of a vehicle by said one or more affixing means.

2. The vehicle rack mount apparatus of claim 1, wherein said base plate is substantially rectangular.

3. The vehicle rack mount apparatus of claim 1, wherein said base plate is substantially the same width and length of said roll bar of said vehicle.

4. The vehicle rack mount apparatus of claim 1, wherein said base plate is substantially rectangular.

5. The vehicle rack mount apparatus of claim 1, wherein each of said two or more rack arms is comprised of a hole configured to receive one end of said rack bar.

6. The vehicle rack mount apparatus of claim 1, wherein a rack bar is removably affixed to said two or more rack arms by way of two or more screws.

7. The vehicle rack mount apparatus of claim 1, wherein a rack bar is removably affixed to said two or more rack arms by way of two or more bolts.

8. The vehicle rack mount apparatus of claim 1, further comprising two or more dampening devices attached to said one or more affixing means.

9. The vehicle rack mount apparatus of claim 8, wherein said dampening devices are configured to reduce damage to said roll bar of said vehicle.

10. The vehicle rack mount apparatus of claim 8, wherein said dampening devices are rubber washers.

11. The vehicle rack mount apparatus of claim 8, wherein said dampening devices are metal washers.

12. The vehicle rack mount apparatus of claim 8, wherein said dampening devices are rubber plugs.
